(19) United States
(12) Patent Application Publication
(10) Pub. No.: US 2009/0230052 A1
(43) Pub. Date: Sep. 17, 2009

(54) HYDROGEN SULFIDE FILTER

(75) Inventor: Gary Hunsinger, Rochester, NY (US)

Correspondence Address: HOFFMAN WARNICK LLC, 75 STATE STREET, 14TH FLOOR, ALBANY, NY, 12207, US

(73) Assignee: SHAWNDRA PRODUCTS, INC., Lima, NY (US)

(21) Appl. No.: 12/045,940

(22) Filed: Mar. 11, 2008

(51) Int. Cl. B01D 29/07; B01D 39/20; B01D 39/16

(52) U.S. Cl. 210/498; 210/500.26

(57) ABSTRACT

A filter material for a filter system and method of filtering a fluid are disclosed. The filter system may include a filter material capable of capturing hydrogen sulfide (H₂S) from a fluid, where the filter material is disposed between a first and second filter media.

### RELATED APPLICATIONS

The present application claims the benefit of co-pending provisional application No. 60/984536, filed on Nov. 1, 2007 and co-pending provisional application No. 61/026274 filed on Feb. 5, 2008, both of which are hereby incorporated by reference.

### BACKGROUND

1. Technical Field

The disclosure relates generally to filters, and more particularly, to a filter having a filter material for capturing hydrogen sulfide (H₂S).

2. Related Art

Filter systems are commonly used for a large number of purposes and applications. In some applications, the use of a filter system is necessary for removing undesired elements that may contaminate a reaction or reduce the performance of a device/product/machine/system. Such applications may include a fuel cell system, a filtration system for a particular fuel (e.g., petroleum gas, natural gas, etc.), a water filtration system, an air filtration system, etc. A filter system for a fluid may include a particulate filter and a chemical filter. The particulate filter serves to remove dust, particles, granules, gravel, debris, etc., while the chemical filter serves to remove specific chemicals, not desired in the fluid. Examples of such undesirable chemicals or contaminants include hydrocarbons, oxides of sulfur, oxides of nitrogen, oxides of carbon and hydrogen sulfide, etc.

Filters for removing particulates may use membranes or layers of granular materials. As to filters for chemical contaminants, some commonly used filtration and/or purification techniques include: ion-exchange, distillation, osmosis, reverse osmosis, chemical adsorption, precipitation, coagulation, oxidation, flocculation, etc.

Chemical contaminants may be toxic and the removal of such contaminants requires careful handling in view of environmental concerns and governmental restrictions as to the release/disposal of such contaminants. Industrial retrieval of hydrocarbon fuels requires the filtration of contaminants like hydrogen sulfide, which is toxic and hazardous when released into the environment. For example, hydrogen sulfide is usually converted into molten sulfur or other stable compounds before disposal.

### SUMMARY

A filter and filter system for the removal and/or disposal of particulates and/or chemical(s), including hydrogen sulfide (H₂S), is disclosed. An embodiment of the filter system includes a filter material between two filter media, each filter media providing coalescing of liquid and particulate for removal thereof. The filter material includes an absorbent material having a surface configuration that exposes the absorbent material to a fluid passing there through. The absorbent material may include various chemical components and take the form of an absorbent fill, a single or multi-layered composite pack, and/or the like. The filter system may include a casing for housing the filter material and filter media.

A first aspect of the disclosure provides a filter material comprising: an absorbent material including: quartz, magnesium oxide, sodium sesquicarbonate dihydrate, aluminum oxide, sodium oxide, silicon oxide, and carbon.

A second aspect of the disclosure provides a filter system comprising: a first and a second filter media for removing particulates from a fluid passing there through; and a filter material disposed between the first and second filter media, wherein the filter material includes an absorbent material configured to capture hydrogen sulfide.

A third aspect of the disclosure provides a method for filtering a fluid, the method comprising: passing the fluid through a first filter media for removing particulates; passing the fluid through an absorbent material for removing hydrogen sulfide; and passing the fluid through a second filter media for removing particulates.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a perspective view of an embodiment of a filter system according to the disclosure.

FIG. 2 is a top view of a section of the filter system illustrated in FIG. 1.

FIG. 3 is a perspective view of an embodiment of the filter material illustrated in FIG. 1 and FIG. 2.

FIG. 4 is a perspective view of another embodiment of the filter material illustrated in FIG. 1 and FIG. 2.

FIG. 5 is a side view of a screw-type fastener for an end cap illustrated in FIG. 1.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

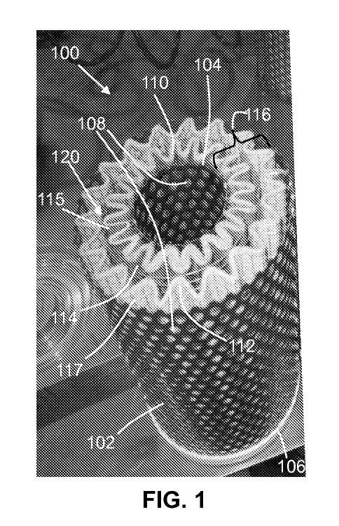

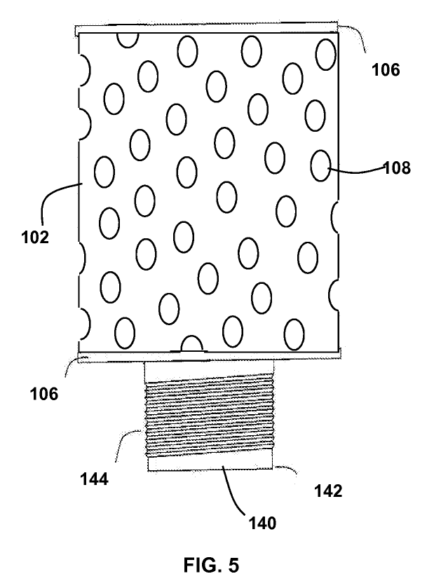

FIG. 1 illustrates an embodiment of a filter system 100 for filtering particulates and one or more chemicals, including hydrogen sulfide (H₂S), from a fluid (e.g., a gas or liquid) according to the disclosure. In particular, filter system 100 can be used to filter a gas (e.g., natural gas, air, or the like), and can remove liquid and/or particulates in the gas, as well as hydrogen sulfide. Filter system 100 includes an outer core casing wall 102 and an inner core casing wall 104 coupled together by end caps 106 to form a concentric casing 116. Filter system 100 is shown with one end cap 106 removed for viewing. Inner core casing wall 104 and outer core casing wall 102 may include, for example, carbon steel, stainless steel or other rigid material capable of withstanding exposure to a noxious gas. Inner core casing wall 104 and outer core casing wall 102 may include perforations 108 that allow the fluid to pass there through. End caps 106 may include, for example, molded urethane or metal. As shown in FIG. 5, an end cap 106 may include a screw-type fastener 140 such as that disclosed in U.S. Pat. No. 7,294,160, which is incorporated herein by reference. In this case, the end cap 106 may be secured to concentric casing 116 (FIG. 1) with screw-type fastener 140 having a shaft 142 that is threaded 144 (FIG. 5).

Returning to FIG. 1, within concentric casing 116, a first filter media 110 adjacent to inner core casing wall 104 is provided for filtering a fluid by, for example, coalescing particulates to facilitate the removal thereof. A second filter media 112 adjacent to outer core casing wall 102 is arranged in a similar manner as first filter media 110 with respect to inner core casing wall 104 and also provides filtering (e.g., by coalescing particulates) and migration protection of the fluid. Migration protection is achieved by providing a barrier to prevent moisture from re-entering the filtered fluid. Each filter media 110, 112 may be pleated and/or wire bound for coalescing of particulate and debris. Filter media 110, 112 may include but is not limited to, for example, borosilicate micro fiberglass, which may be configured in multiple (e.g., five) layers encapsulated by a wire mesh 117 and/or a screen 115.

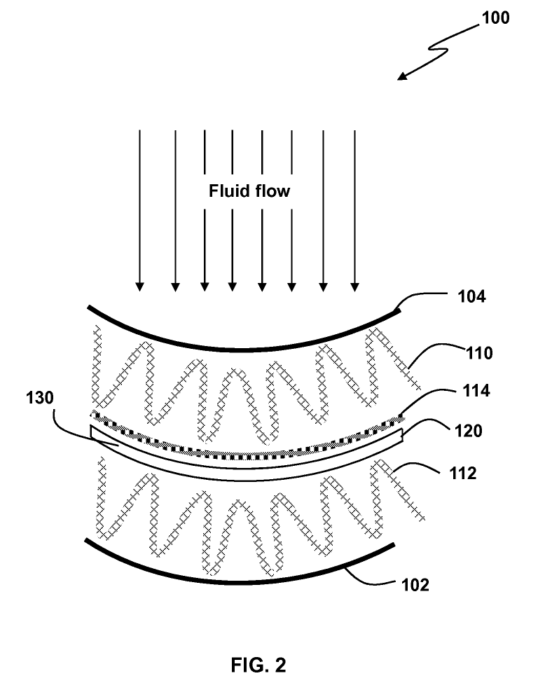

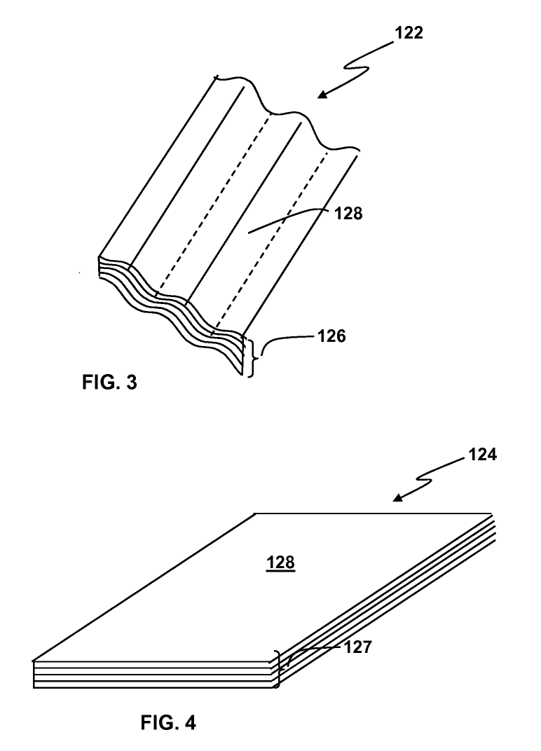

FIG. 2 shows a section of a top view of the filter system 100 from FIG. 1 illustrating a cross-section of filter system 100. A filter material 120 is disposed between filter media 110 and 112. In an embodiment, a reinforcement 114 in the form of, for example, a wired framework or gauze, may be included on either side or both sides of filter material 120 to provide support thereof. Filter material 120 includes an absorbent material 130. In an embodiment, filter material 120 is in the form of an absorbent fill (e.g., granular pack) that comprises absorbent material 130. Additionally, as shown in FIGS. 3 and 4, filter material 120 may comprise a multi-layered composite pack 122 (FIG. 3), 124 (FIG. 4). The multi-layered composite pack 122, 124 may include approximately 2 to 5 layers of composite absorbent material 130 included therein. In either case, the filter material 120 includes a surface 128 for exposing the absorbent material 130 to a fluid passing there through. Surface 128 can comprise any configuration that provides a surface for exposing absorbent material 130 to a fluid passing there through within the confines of the curvature of the concentric casing 116 (FIG. 1).

When filter material 120 comprises one or more layers, surface 128 may include, but is not limited to: a flat configuration or an undulating configuration. For example, FIG. 3 shows a multi-layered composite pack 122 with an undulating (e.g., fluted) configuration 126 for exposing filter material 120 in multi-layered composite pack 122 to a fluid passing there through. It is understood that surface 128 can comprise other types of undulating configurations, such as pleated, regular wave-like, irregular wave-like, and/or the like. FIG. 4 shows an alternative multi-layered composite pack 124 with a flat configuration 127, which may be adapted to, for example, the curvature of the concentric casing 116 (FIG. 1). Returning to FIG. 2, when filter material 120 comprises an absorbent fill, the surface can be formed using, for example, reinforcement(s) 114, or the like.

Absorbent material 130 may include one or more absorbent materials including, but not limited to: activated carbon, molecular sieve, sodium dihydrate, quartz, magnesium oxide, sodium sesquicarbonate dihydrate (Na₂CO₃.NaHCO₃.2H₂O), aluminum oxide, sodium oxide, silicon oxide, carbon, and/or the like. Activated carbon may be a vapor phase activated carbon (from coal), for example, AP4-60 (4 mm activated carbon pellet) offered by Calgon Carbon Corporation. An alternative to sesquicarbonate dihydrate may be sodium tartrate dihydrate (Na₂C₄H₄06.2H₂0). In one embodiment, filter material 120 may include substantially equal parts (by percentage volume) of activated carbon and molecular sieve. In another embodiment, absorbent material 130 may include substantially equal parts of molecular sieve and sodium dihydrate. Another embodiment of absorbent material 130 may include substantially all activated carbon.

Other embodiments of absorbent material 130 may include various combinations of several of the absorbent materials described above. In one embodiment, absorbent material 130 comprises a combination of: approximately (0-4)% by volume of quartz; approximately (0-5)% by volume of magnesium oxide; approximately (9-15)% by volume of sodium sesquicarbonate dihydrate; approximately (10-16)% by volume of aluminum oxide; approximately (10-16)% by volume of sodium oxide; approximately (21-27)% by volume of silicon oxide; and approximately (32-38)% by volume of carbon. In another embodiment, absorbent material 130 may include a combination of: approximately 1% by volume of quartz, approximately 2% by volume of magnesium oxide, approximately 12% by volume of sodium sesquicarbonate dihydrate (Na₂CO₃.NaHCO₃.2(H₂O)), approximately 13% by volume of aluminum oxide, approximately 13% by volume of sodium oxide, approximately 24% by volume of silicon oxide, and approximately 35% by volume of carbon. It is understood that this combination is only illustrative. To this extent, one or more of the percentages could be varied. For example, a combination could include more sodium sesquicarbonate dihydrate and less carbon. The compositions in these embodiments may be modified to include activated carbon, molecular sieve and/or sodium dihydrate.

In one embodiment, activated carbon may include carbon pellets. Molecular sieve may include zeolite or other porous material. An embodiment of filter material 120 has demonstrated an ability to remove at least approximately 40% by volume of the hydrogen sulfide (H₂S) from a fluid passing there through, and may remove hydrogen sulfide from the fluid up to as high as approximately 99.5% by volume. For example, a gas including 50 parts per million (ppm) hydrogen sulfide exited an embodiment of filter system 100 (FIG. 1) including only 0.4 ppm hydrogen sulfide.

Referring to FIG. 2, in operation, a fluid, which may include, inter alia, hydrogen sulfide (H₂S), enters through perforations 108 (FIG. 1) of the center of inner core casing wall 104 and passes through first filter media 110 where particulates are removed (e.g., coalesced). From first filter media 110, the fluid passes through filter material 120, which filters one or more chemicals, including H₂S, before flowing to second filter media 112. Second filter media 112 provides further removal of the particulates (e.g., coalescing and migration protection) from the fluid that passes there through. Filtered fluid is allowed to flow through perforations 108 of outer casing wall 102 for further processing (e.g., treatment, collection, storage, and/or the like).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Any embodiment disclosed herein is for the purposes of explaining the principles of the disclosure and the practical application, and to enable others of ordinary skill in the art to understand the disclosure and is not intended to be limiting to the particular use contemplated.

What is claimed is:

1. A filter material comprising:
an absorbent material including: quartz, magnesium oxide, sodium sesquicarbonate dihydrate, aluminum oxide, sodium oxide, silicon oxide, and carbon.

2. The filter material of claim 1, further comprising a surface for exposing the absorbent material to a fluid passing there through, wherein the surface includes a configuration selected from a group consisting of: flat and undulating.

3. The filter material of claim 1, wherein the filter material comprises at least one of:
an absorbent fill or a multi-layered composite pack.

4. The filter material of claim 3, wherein the multi-layered composite pack includes two to five layers.

5. The filter material of claim 1, wherein the quartz ranges from approximately 1% by volume to approximately 4% by volume, the magnesium oxide ranges from approximately 1% by volume to approximately 5% by volume, the sodium sesquicarbonate dihydrate ranges from approximately 9% by volume to approximately 15% by volume, the aluminum oxide ranges from approximately 10% by volume to approximately 16% by volume, the sodium oxide ranges from approximately 10% by volume to approximately 16% by volume, the silicon oxide ranges from approximately 21% by volume to 27% by volume, and the carbon ranges from approximately 32% by volume to approximately 38% by volume.

6. The filter material of claim 1, wherein the absorbent material further includes at least one component selected from a group consisting of: activated carbon, molecular sieve and sodium dihydrate.

7. A filter system comprising:
a first and a second filter media for removing particulates from a fluid passing there through; and
a filter material disposed between the first and second filter media, wherein the filter material includes an absorbent material configured to capture hydrogen sulfide.

8. The filter system of claim 7, wherein the absorbent material includes at least one of: activated carbon, molecular sieve, sodium dihydrate, quartz, magnesium oxide, sodium sesquicarbonate dihydrate, aluminum oxide, sodium oxide, silicon oxide, carbon, and a combination thereof.

9. The filter system of claim 7, further comprising a surface for exposing the absorbent material to a fluid passing there through, wherein the surface includes a configuration selected from a group consisting of: flat or undulating.

10. The filter system of claim 7, wherein the filter material includes at least one of: an absorbent fill or a multi-layered composite pack.

11. The filter system of claim 10, wherein the multi-layered composite pack includes two to five layers.

12. The filter system of claim 7, wherein the absorbent material includes a combination of: quartz, magnesium oxide, sodium sesquicarbonate dihydrate, aluminum oxide, sodium oxide, silicon oxide, and carbon.

13. The filter system of claim 12, wherein the quartz ranges from approximately 1% by volume to approximately 4% by volume, the magnesium oxide ranges from approximately 1% by volume to approximately 5% by volume, the sodium sesquicarbonate dihydrate ranges from approximately 9% by volume to approximately 15% by volume, the aluminum oxide ranges from approximately 10% by volume to approximately 16% by volume, the sodium oxide ranges from approximately 10% by volume to approximately 16% by volume, the silicon oxide ranges from approximately 21% by volume to 27% by volume, and the carbon ranges from approximately 32% by volume to approximately 38% by volume.

14. The filter system of claim 7, wherein the absorbent material includes at least one component selected from a group consisting of: activated carbon, molecular sieve and sodium dihydrate.

15. The filter system of claim 7, wherein the first filter media and the second filter media each include a pleated, wire bound filter media for removing particulates.

16. The filter system of claim 15, wherein the pleated, wire bound filter media includes borosilicate micro fiberglass encapsulated by a wire mesh and a screen.

17. The filter system of claim 7, further including a casing having an outer core casing wall and an inner core casing wall coupled together by at least one end cap.

18. The filter system of claim 17, wherein the at least one end cap includes a screw-type fastener.

19. A method for filtering a fluid, the method comprising:
passing the fluid through a first filter media for removing particulates;
passing the fluid through an absorbent material for removing hydrogen sulfide; and
passing the fluid through a second filter media for removing particulates.

20. The method of claim 19, wherein the absorbent material includes: quartz, magnesium oxide, sodium sesquicarbonate dihydrate, aluminum oxide, sodium oxide, silicon oxide, and carbon.

21. The method of claim 19, wherein the absorbent material is disposed between the first and second filter media.
